(19) United States
(12) Patent Application Publication
(10) Pub. No.: US 2010/0076689 A1
(43) Pub. Date: Mar. 25, 2010

(54) Method for extracting waveform attributes from biological signals

(75) Inventors: Rishikant K. Chaturvedi, Hatfield, PA (US); Michael S. Toth, Allentown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Ari Products and Chemicals, Inc., Allentown, PA (US)

(21) Appl. No.: 12/284,930

(22) Filed: Sep. 25, 2008

(51) Int. Cl. G06F 19/00

(52) U.S. Cl. 702/19

(57) ABSTRACT

A computer-based method for extracting waveform attributes from a biological (bio) signal includes the steps of receiving a raw waveform data corresponding to the bio signal, upon receiving a user-initiated signal, communicating the raw data to a first waveform analysis tool to obtain a first waveform attribute, and upon receiving the same user-initiated signal, communicating the raw data to a second waveform analysis tool to obtain a second waveform attribute. The first tool is different from the second tool and the first attribute is different from the second attribute. The method also includes outputting the first and second waveform attributes into a human-readable format.

### BACKGROUND OF THE INVENTION

This invention relates to a method for extracting waveform attributes from biological signals.

Medical research often relies on the availability of easily understandable and clinically meaningful information. During the course of a research project, numerous medical data may be aggregated for further study. The medical data often includes biological (bio) signals, such as electrocardiogram (EKG or ECG), heart rate variability (HRV) and electroencephalogram (EEG) signals. Bio signals are generally collected by manufacturer-specific data collection devices, which are configured to store the bio signals as raw waveform data. Access to the raw data is then provided to researchers, who must interpret this data.

Often the raw data cannot be directly interpreted by the researchers. Without further processing, the raw data may simply be a series of meaningless values. A problem with conventional hardware and software tools is that, while they may have the ability to generate some meaningful data, the process for obtaining the data can be burdensome. Users may be faced with the difficulty of interfacing with numerous different tools. Another problem is that the conventional tools may be not be able to calculate certain types of meaningful data, the need for which may not have been anticipated at the time the conventional tools were developed.

Accordingly, it can be seen that, in order to facilitate waveform analysis, it is desirable to have tools which can render the raw data meaningful. It is further desirable to have a single tool for generating as much meaningful data as possible so that reliance on multiple different tools is reduced.

### BRIEF SUMMARY OF THE INVENTION

According to a first aspect of the present invention, there is provided a computer-based method for extracting waveform attributes from a biological (bio) signal, comprising: receiving a raw waveform data corresponding to the bio signal; upon receiving a user-initiated signal, communicating the raw data to a first waveform analysis tool to obtain a first waveform attribute; upon receiving the same user-initiated signal, communicating the raw data to a second waveform analysis tool to obtain a second waveform attribute, wherein the first tool is different from the second tool and the first attribute is different from the second attribute; and outputting the first and second waveform attributes into a human-readable format.

According to a second aspect of the present invention, there is provided a computer-readable medium having stored thereon a series of instructions executable by a processor for extracting waveform attributes from a biological (bio) signal, the instructions configured to cause the processor to perform the steps of: receiving a raw waveform data corresponding to the bio signal; upon receiving a user-initiated signal, communicating the raw data to a first waveform analysis tool to obtain a first waveform attribute; upon receiving the same user-initiated signal, communicating the raw data to a second waveform analysis tool to obtain a second waveform attribute, wherein the first tool is different from the second tool and the first attribute is different from the second attribute; and outputting the first and second attributes into a human-readable format.

### BRIEF DESCRIPTION OF SEVERAL VIEWS OF THE DRAWINGS

FIG. 1 shows an example of a system for extracting waveform attributes from a biological signal according to an example embodiment of the present invention.

FIG. 2 shows an example of a memory of a waveform processing device according to an example embodiment of the present invention.

FIG. 3 shows an example of a method for extracting waveform attributes from a biological signal according to an example embodiment of the present invention.

FIG. 4 shows an example of a set of extracted waveform attributes according to an example embodiment of the present invention.

FIG. 5 shows an example of a user interface according to an example embodiment of the present invention.

### DETAILED DESCRIPTION OF THE INVENTION

Exemplary embodiments of the present invention will be described with reference to the extraction of waveform attributes from biological (bio) signals. In particular, the bio signals described are electrocardiogram (EKG or ECG) signals. However, it will be appreciated that the present invention may be applied to other types of bio signals, such as heart rate variability (HRV) and electroencephalogram (EEG) signals.

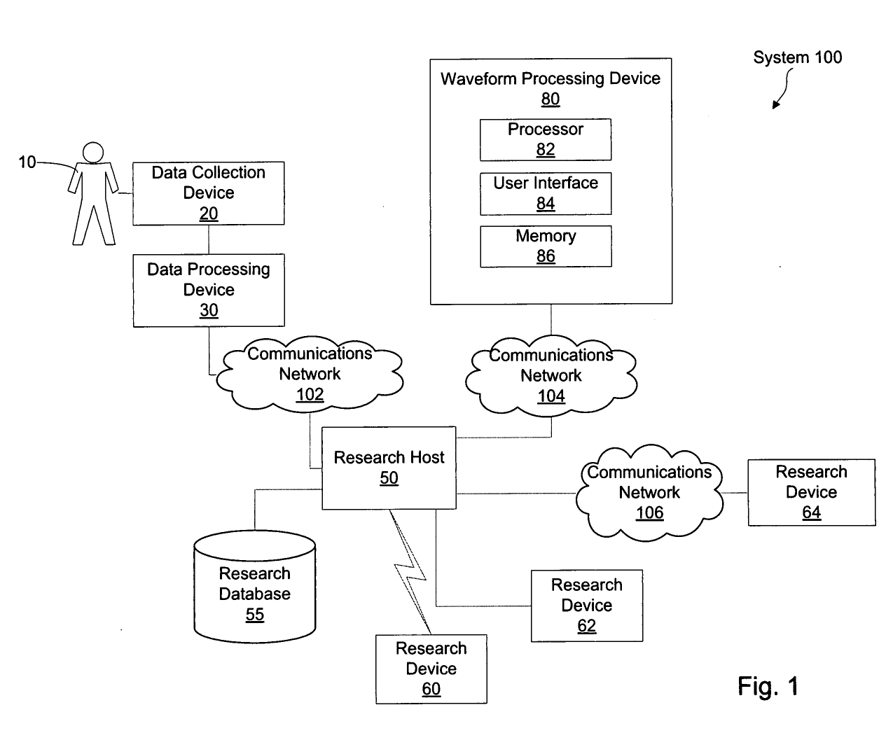

FIG. 1 shows an example of a system 100 for extracting waveform attributes from bio signals according to an example embodiment of the present invention. The system 100 may include a bio signal source such as a patient 10 from whom bio signals are collected by a data collection device 20. The system 100 may also include a data processing device 30, a research host 50, a research database 55, one or more research devices 60, 62 and 64, a waveform processing device 80, and one or more communications networks 102, 104, and 106. As explained below, the bio signals collected by the collection device 20 may be transmitted to the research database 55, which may be accessed by researchers operating the research devices 60, 62 and 64.

The communications networks 102, 104 and 106 may be configured to enable data communication between the various components of the system 100. In particular, the communications networks 102, 104 and 106 may respectively enable communications between the research host 50 and each of the data processing device 30, the waveform processing device 80 and the research device 64.

The communications networks 102, 104 and 106 may be any type of wired or wireless network including, for example, a virtual private network, a local area network, a wide area network, the Internet, etc. The communications networks 102, 104 and 106 may also include any number of sub-networks. It may also be possible for the system components to communicate directly with each other. For example, as shown in FIG. 1, the research device 62 may be in direct communication with the research host 50 and the research device 60 may be in wireless communication with the research host 50, e.g., via a direct IEEE 802.1x connection.

The patient 10, the collection device 20 and the data processing device 30 may be located at a place of medical treatment, such as a hospital, a clinic or a private practitioner's office. The patient 10 may be treated for a heart-related condition, although heart conditions may not always be the reason for collecting EKG signals. For example, heart monitoring may often be performed as a matter-of-course for many hospital admitted patients.

The collection device 20 may be configured to collect bio signals from the patient 10 and transmit the bio signals to the data processing device 30 in the form of waveform data, e.g., waveforms created by digitizing the bio signals. Alternatively, the collection device 20 may be configured to transmit analog bio signals to the data processing device 30 for further processing, e.g., analog-to-digital conversion. In one embodiment, the collection device 20 may collect the patient data directly, e.g., using an EKG sensor. Alternatively, the collection device 20 may receive the patient data from a separate sensor such as an implanted pacemaker or an implantable cardioverter-defibrillator.

The data processing device 30 may be a general purpose computing device, e.g., a personal computer, configured to receive the waveform data from the collection device 20. The data processing device 30 may be operated by medical personnel, such as a physician, a medical technician, or other person responsible for collecting the bio signals. In one embodiment, the data processing device 30 may receive the waveform data directly from an internal database of the collection device 20, e.g., via a hardware arrangement such as a wired data port or a wireless connection. In an alternative embodiment, the collection device 20 may store the waveform data onto a portable computer-readable medium such as a floppy disk or a CD-ROM. After the waveform data is received, it may be processed, e.g., signal processed, aggregated with other data from the patient's medical records, or anonymized by removing patient identifying information.

The research host 50 may include one or more computing devices, e.g., a research server configured to receive the waveform data from the data processing device 30. The waveform data may be transmitted to the research host 50 either manually or at predetermined time intervals, e.g., once a week, once a month, anytime new waveform data is generated, etc. In another embodiment, the research host 50 may be configured to poll the data processing device 30, e.g., at the request of a research personnel or automatically. The research host 50 may be configured to store the waveform data at the research database 55.

The research database 55 may reside on a server running a database application such as Oracle or SQL Server. The research database 55 may include any number of waveform data from a variety of sources, such as a plurality of hospitals participating in a research project, academic institutions, private practitioners, research clinics, etc. Generally, data stored at the research database 55 is anonymized through the use of research identifiers, which may be assigned to patients participating in a research project, e.g., a clinical study, and used to index the waveform data.

The research devices 60, 62 and 64 may be computing devices communicating with the research host 50 and may be configured to transmit requests for data records, e.g., the waveform data or other medical records. The requests may specify a research identifier as a parameter, e.g., downloading a individual patient's waveform data. The requests may also be general requests for a plurality of patient waveform data. In addition, the requests may specify search parameters for obtaining waveform data that fit specified criteria, such as data corresponding to specific heart conditions, e.g., fibrillation, tachyarrhythmia, ventricular events, atrial events, etc.

The waveform processing device 80 may be operated by the same personnel responsible for collecting the bio signals. Alternatively, a research administrator or third-party contractor may operate the waveform processing device 80. Components of the waveform processing device 80 may include a processor 82, a user interface 84 and a memory 86. The waveform processing device 80 may be configured to extract waveform attributes from the waveform data using any number of extraction techniques, as discussed below. Although shown as a separate device, the waveform processing device 80 may, in other embodiments, be integrated into another device such as the data processing device 30 or the research host 50 using any combination of hardware and/or software.

The processor 82 may include a microprocessor, an integrated circuit or series of integrated circuits, analog, digital, and other hardware components. The processor 82 may be configured to execute instructions contained in the memory 86.

The user interface 84 may be a graphical user interface displayed on a monitor or other display arrangement of the waveform processing device 80. The user interface 84 may be configured to enable a user to select waveform data for processing. For example, the user may select one or more waveform data stored in the research database 55. The selected data may then be retrieved and processed to generate the waveform attributes. In some embodiments, retrieval may be optional if the waveform data is, for example, transmitted directly to the waveform processing device 80 by the data processing device 30.

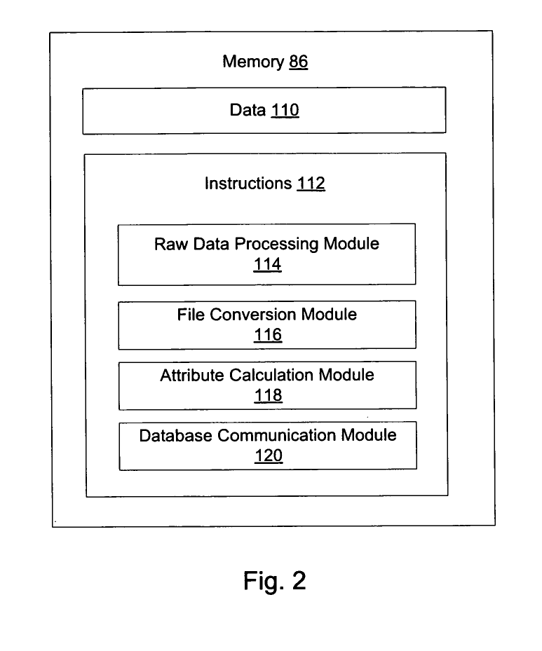

The memory 86 may include any type of readable or writable memory, include RAM, ROM, flash memory, an optical or electromagnetic drive, a compact disc, etc. Referring to FIG. 2, the memory 86 may include data 110 and instructions 112. The data 110 may include program data such as the waveform attributes, program variables and the waveform data.

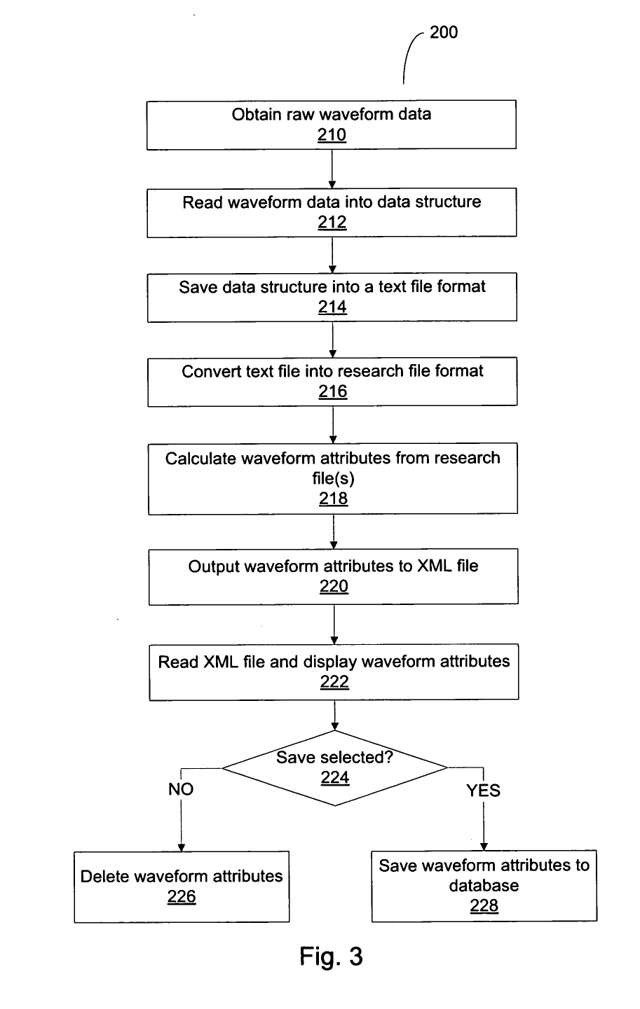

The instructions 112 may include one or more hardware or software modules configured to perform attribute extraction, including a raw data processing module 114, a file conversion module 116, an attribute calculation module 118 and a database communication module 120. The operation of each module will be described below with reference to FIG. 3.

FIG. 3 shows an example of a method 200 according to an example embodiment of the present invention. The method 200 may be implemented in any combination of hardware and/or software on the system 100, e.g., at the waveform processing device 80. However, the method 200 may also be successfully implemented in other systems or devices capable of processing the waveform data. As described below, the method 200 may be used to extract the waveform attributes from raw waveform data. The waveform attributes may be displayed to the user and, optionally, saved to the research database 55.

In 210, the raw data processing module 114 may configure the processor 82 to obtain raw waveform data by, for example, selecting one or more waveform data stored at the research database 55. The raw waveform data may be obtained manually, e.g., selected by the user, or automatically, e.g., automatic retrieval of all waveform data or automatic retrieval of waveform data which lack corresponding waveform attributes.

In 212, the waveform data may be read into a corresponding data structure such as a one-dimensional array, each entry of which may correspond to a single byte of waveform data, e.g., a byte-by-byte array. It will be appreciated, however, that other data structures and storage schemes may be used for reading the waveform data, including, but not limited to, multi-dimensional arrays, binary files, and spreadsheet, e.g., Microsoft Excel, files.

In 214, the data structure may be saved into a text file format such as an ASCII, an MS-DOS, a rich text formatted, or a Unicode text file. The text file generated in this manner may be a temporary file from which the waveform attributes are extracted, either during a single waveform processing session or during multiple sessions. An advantage of saving the data structure to the text file may be that the waveform attributes need not be extracted immediately. This may be beneficial where, for example, processing power is limited and waveform data are too numerous to process immediately.

In 216, the file conversion module 116 may configure the processor 82 to convert the text file into a research file format. Although not strictly necessary, converting to the research file format may facilitate attribute extraction because the research file format may be a standardized or commonly accepted format used by waveform analysis tools. In one embodiment, the research file format may be a Physionet format such as a WFDB file. The conversion may be performed using any number of file conversion tools, such as those provided by the PhysioToolkit software. A result of the conversion may be one or more research files, such as a WFDB signal file containing the waveform data and a WFDB header file describing the signal file.

In 218, the attribute calculation module 118 may configure the processor 82 to calculate one or more waveform attributes from the research file(s). The calculation may be initiated upon receiving a signal from the user. The user-initiated signal may trigger the providing of the waveform data to one or more waveform analysis tools executed by the processor 82. The waveform attributes may include, but are not limited to, statistical (trend) attributes and attributes corresponding to anomalous activity. In particular, the waveform attributes may include an average r-r rate, a standard deviation and a maximum derivative of an r-r rate. The waveform attributes may be calculated using any number of waveform analysis tools, including PhysioToolKit and EP Limited, an open source EKG analysis (OSEA) software compatible with the WFDB file format. The waveform analysis tools may be executed on the processor 82, either sequentially or in parallel with one another. Other waveform analysis tools may also be used in conjunction with or as an alternative to PhysioToolKit and EP Limited. The other waveform analysis tools may be configured to calculate the same waveform attributes, but may also be configured to calculate attributes not obtainable using either PhysioToolKit or EP Limited. Examples of such attributes include a QRS length, a total number of inverted T waves, and an average rate of inverted T wave occurrence.

In some embodiments, the waveform data may be de-noised, e.g., by removing baseline drift, prior to calculating the waveform attributes. Noise removal may be performed by the waveform analysis tools themselves. Alternatively, the attribute calculation module 118 may include instructions for removing noise before providing the waveform data to the waveform analysis tools.

In 220, the waveform attributes may be output to an Extensible Markup Language (XML) file. Although it may be possible to output the waveform attributes to a display arrangement of the waveform processing device 80, it will be appreciated that the XML file may be configured to display the waveform attributes in an easy-to-read format by specifying how the waveform attributes should appear on the display.

In 222, the XML file may be read and waveform attributes displayed in a user interface, e.g., the user interface 84. The waveform attributes may be displayed in conjunction with information corresponding to the waveform data from which the waveform attributes were generated, such as waveform names, research identifiers and collection dates. After the waveform attributes are displayed, the user may be presented with an option to save the waveform attributes to the research database 55.

In 224, a determination may be performed whether the user has selected to save the waveform attributes.

If the user chooses not to save the waveform attributes, then the method 200 proceeds to 226, where the waveform attributes may be deleted, e.g., by deleting the text file, the research file(s) and the XML file. In addition, any temporary workspaces such as data caches may be cleared.

If the user chooses to save the waveform attributes, then the method 200 proceeds to 228, where the database communication module may configure the processor 82 to transmit the waveform attributes to the research host 50.

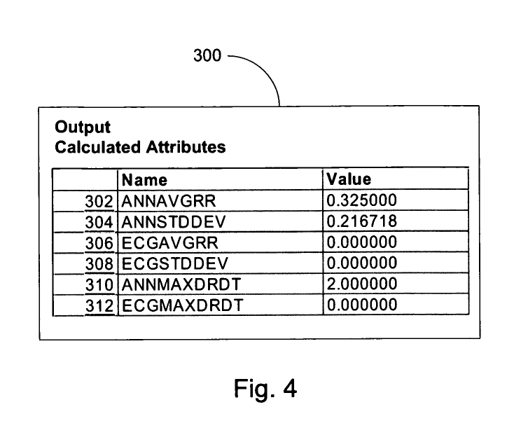

FIG. 4 shows an example of a set of extracted waveform attributes 300 according to an example embodiment of the present invention. The attribute set 300 may be formatted for display in accordance with the XML file, which may specify that the waveform attributes be displayed in column format with a first column displaying the waveform attribute names and a second column displaying corresponding waveform attribute values. As shown in FIG. 4, the attribute set 300 may include a first average r-r rate 302, a first standard deviation 304, a second average r-r rate 306, a second standard deviation 308, a first r-r rate maximum derivative 310 and a second r-r rate maximum derivative 312. The first average r-r rate 302, the first standard deviation 304 and the first maximum derivative 310 may be calculated using EP Limited, while the second average r-r rate 306, the second standard deviation 308 and the second maximum derivative 312 may be calculated using PhysioToolKit.

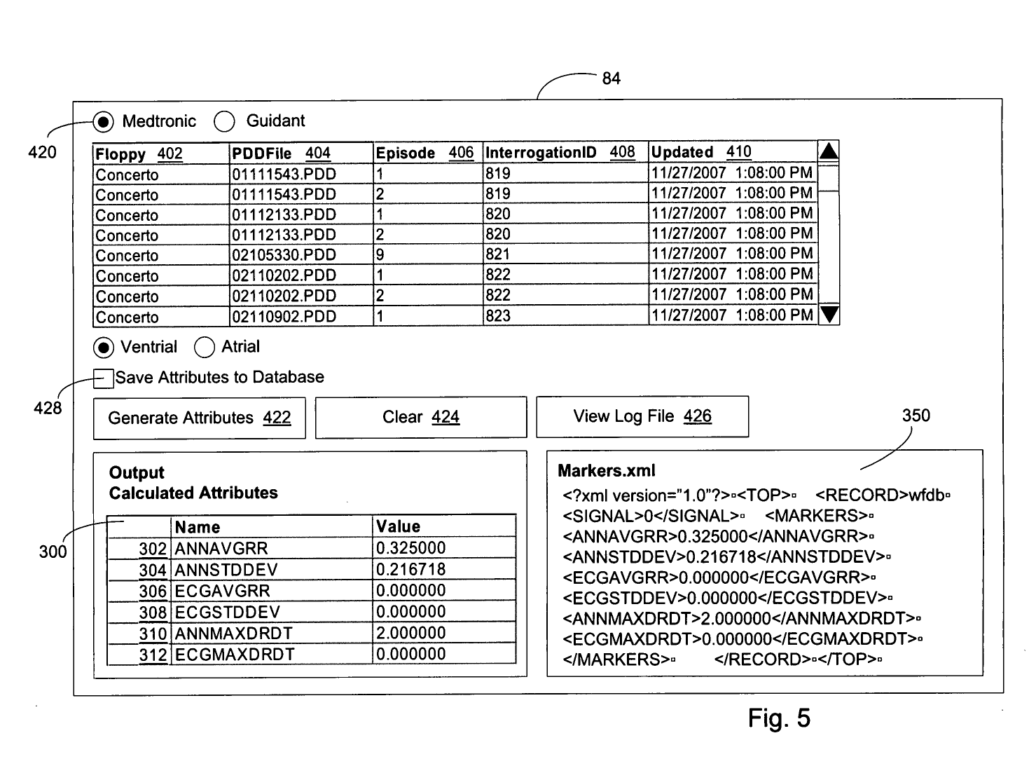

FIG. 5 shows an example of the user interface 84 according to an example embodiment of the present invention. The user interface 84 may include a data source selection option 420 allowing the user to select from one or more data sources, such as waveform data collected using the collection devices of different manufacturers. The user interface 84 may also display information corresponding to the waveform data in the selected data source. The information may be displayed in column format, with a first column 402 displaying database types of each waveform data, a second column 404 displaying file names of the raw waveform data, a third column 406 displaying event or episode counts, a fourth column 408 displaying interrogation IDs (e.g., research identifiers), and a fifth column 410 displaying timestamps corresponding to the last time the waveform data was modified.

The user interface 84 may include an option 422 to generate the waveform attributes from the selected waveform data. An option 424 may be provided to clear the generated waveform attributes from display and/or from memory. An option 426 may be provided to view a log file in which recent program waveform processing activity may be recorded. An option 428 may be provided to save the generated waveform attributes to a database, e.g., a local database or the research database 55.

As shown in FIG. 5, a portion of the user interface 84 may be configured to display the attribute set 300. The attribute set 300 may be displayed in conjunction with a corresponding XML file 350 such that the user may view both simultaneously. The contents of the user interface 84 may be selectable, allowing the user to copy selected portions for pasting into a separate document or program window, e.g., an XML editor or a spreadsheet program.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A computer-based method for extracting waveform attributes from a biological (bio) signal, comprising:
receiving a raw waveform data corresponding to the bio signal;
upon receiving a user-initiated signal, communicating the raw data to a first waveform analysis tool to obtain a first waveform attribute;
upon receiving the same user-initiated signal, communicating the raw data to a second waveform analysis tool to obtain a second waveform attribute, wherein the first tool is different from the second tool and the first attribute is different from the second attribute; and
outputting the first and second waveform attributes into a human-readable format.

2. The method of claim 1, further comprising:
storing the first and second attributes in a database from which the raw data was obtained.

3. The method of claim 1, wherein the first and second attributes each include one of an average r-r rate, a standard deviation, a maximum derivative of an r-r rate, a QRS length, a total number of inverted T waves and an average rate of inverted T wave occurrence.

4. The method of claim 1, wherein the second tool is configured to compute the second attribute after removing noise from the raw data.

5. The method of claim 1, wherein the bio signal is one of an electrocardiogram signal, a heart beat variability signal and an electroencephalogram signal.

6. The method of claim 1, wherein the step of outputting includes:
converting the first and second attributes from a machine-readable format to the human-readable format; and
displaying the converted attributes.

7. The method of claim 6, wherein the machine-readable format is an Extensible Markup Language (XML) format.

8. The method of claim 1, further comprising:
reading the received raw data into a data structure; and
saving the data structure into a first file format.

9. The method of claim 8, wherein the data structure is a byte-by-byte array.

10. The method of claim 8, wherein the first file format is a text file.

11. The method of claim 8, further comprising:
converting the saved data structure from the first file format into a second file format from which both the first and second attributes are calculated.

12. The method of claim 11, wherein the second file format is a Physionet format.

13. A computer-readable medium having stored thereon a series of instructions executable by a processor for extracting waveform attributes from a biological (bio) signal, the instructions configured to cause the processor to perform the steps of:
receiving a raw waveform data corresponding to the bio signal;
upon receiving a user-initiated signal, communicating the raw data to a first waveform analysis tool to obtain a first waveform attribute;
upon receiving the same user-initiated signal, communicating the raw data to a second waveform analysis tool to obtain a second waveform attribute, wherein the first tool is different from the second tool and the first attribute is different from the second attribute; and
outputting the first and second attributes into a human-readable format.

14. The computer-readable medium of claim 13, wherein the instructions are configured to cause the processor to perform the step of:
storing the first and second attributes in a database from which the raw data was obtained.

15. The computer-readable medium of claim 13, wherein the first and second attributes each include one of an average r-r rate, a standard deviation, a maximum derivative of an r-r rate, a QRS length, a total number of inverted T waves and an average rate of inverted T wave occurrence.

16. The computer-readable medium of claim 13, wherein the second tool is configured to compute the second attribute after removing noise from the raw data.

17. The computer-readable medium of claim 13, wherein the bio signal is one of an electrocardiogram signal, a heart beat variability signal and an electroencephalogram signal.

18. The computer-readable medium of claim 13, wherein the step of outputting includes:
converting the first and second attributes from a machine-readable format to the human-readable format; and
displaying the converted attributes.

19. The computer-readable medium of claim 18, wherein the machine-readable format is an Extensible Markup Language (XML) format.

20. The computer-readable medium of claim 13, wherein the instructions are configured to cause the processor to perform the steps of:
reading the received raw data into a data structure; and
saving the data structure into a first file format.

21. The computer-readable medium of claim 20, wherein the data structure is a byte-by-byte array.

22. The computer-readable medium of claim 20, wherein the first file format is a text file.

23. The computer-readable medium of claim 20, wherein the instructions are configured to cause the processor to perform the step of:
converting the saved data structure from the first file format into a second file format from which both the first and second attributes are calculated.

24. The computer-readable medium of claim 23, wherein the second file format is a Physionet format.
